(19) United States
(12) Patent Application Publication
(10) Pub. No.: US 2025/0341687 A1
(43) Pub. Date: Nov. 6, 2025

(54) TRANSCEIVER CONNECTOR EXTENSION SYSTEM

(71) Applicant: Dell Products L.P., Round Rock, TX (US)

(72) Inventors: Shree Rathinasamy, Georgetown, TX (US); Padmanabhan Narayanan, Chennai (IN); Jason Christopher Rock, Austin, TX (US)

(21) Appl. No.: 18/655,524

(22) Filed: May 6, 2024

(51) Int. Cl. G02B 6/42

(52) U.S. Cl. CPC G02B 6/4261; G02B 6/428; G02B 6/4284; G02B 6/4268

(57) ABSTRACT

A transceiver connector extension device includes an extension device chassis. A computing device connector is located on a first end of the extension device chassis and is configured to connect to a computing device that is provided in an immersion fluid. A transceiver connector is located on a second end of the extension device chassis that is opposite the first end, and is configured to connect to a transceiver device. The extension device chassis is provided with a length that is configured, when the computing device connector is connected to the computing device that is provided in the immersion fluid and the transceiver device is connected to the transceiver connector, to position a cable coupled to the transceiver device out of the immersion fluid.

### BACKGROUND

The present disclosure relates generally to information handling systems, and more particularly to extending the transceiver connector on information handling systems to prevent cable degradation in immersion cooling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems such as, for example, networking devices (e.g., switch devices), server devices, and/or other computing devices known in the art, are provided in denser and denser configurations and continue to generate higher and higher amounts of heat during their operation, traditional air-cooling techniques are becoming insufficient to properly cool those computing devices and their components. One solution to such issues is immersion cooling techniques that immerse the computing devices in a dielectric, electrically non-conductive immersion fluid that has a significantly higher thermal conductivity than air, with heat removed from the immersed computing devices by allowing the immersion fluid to directly contact the heat producing components in the computing devices while circulating the heated immersion fluid through heat exchangers.

While immersion cooling techniques are highly effective due to the ability of the immersion fluid to absorb relatively large amounts of heat while being relatively easy to circulate, they do raise issues with regard to the use of cables to connect the computing devices in immersion cooling systems. For example, “category” (CAT) Ethernet cables, Fibre Optic cables, Direct Attach Copper (DAC) cables, and/or other cables with PolyVinyl Chloride (PVC)-based cable jackets are the most commonly used cables in immersion cooling systems, and those PVC cable jackets are subject to issues when immersed in the dielectric immersion fluid. For example, PVC cable jackets immersed in dielectric immersion fluid can become hardened, brittle, and/or can otherwise degrade over time, reducing their flexibility and causing them to be damaged when they are subsequently flexed, bent, and/or otherwise used in a manner that they would typically be used when they have not been degraded. As will be appreciated by one of skill in the art in possession of the present disclosure, such damage can interfere with the connectivity cables provide, and can result in data loss, device downtime, and expenditure of relatively significant resources to identify damaged cables and replace them at regular intervals as they are damaged by their immersion in immersion fluid.

Accordingly, it would be desirable to provide to provide an immersion cooling cabling system that addresses the issues discussed above.

### SUMMARY

According to one embodiment, an Information Handling System (IHS) includes an Information Handling System (IHS) chassis that is immersed in an immersion fluid; a port that is accessible on the IHS chassis; a processing system that is housed in the IHS chassis and coupled to the port; a transceiver connector extension device that includes: an extension device chassis including an IHS connector that is located on a first end of the extension device chassis and that is connected to the port; and a transceiver connector that is located on a second end of the extension device chassis that is opposite the first end; a transceiver device that is connected to the transceiver connector; and a cable that is coupled to the transceiver device, wherein the extension device chassis is provided with a length that positions the cable out of the immersion fluid.

### BRIEF DESCRIPTION OF THE DRAWINGS

FIG. 1 is a schematic view illustrating an embodiment of an Information Handling System (IHS).

FIG. 2A is a side view illustrating an embodiment of a transceiver connector extension device that may be provided in the transceiver connector extension system of the present disclosure.

FIG. 2B is a side schematic view illustrating an embodiment of the transceiver connector extension device of FIG. 2A.

FIG. 3 is a flow chart illustrating an embodiment of a method for preventing immersion fluid cable damage using a transceiver connector extension device.

FIG. 4 is a schematic view illustrating an embodiment of a computing device that may be used with the transceiver connector extension device of FIGS. 2A and 2B.

FIG. 5 is a side view illustrating an embodiment of a transceiver device that may be used with the transceiver connector extension device of FIGS. 2A and 2B.

FIG. 6 is a side view illustrating a plurality of the computing devices of FIG. 4 provided in an immersion cooling system.

FIG. 7A is a side view illustrating an embodiment of the transceiver connector extension device of FIGS. 2A and 2B being connected to a computing device in the immersion cooling system of FIG. 6.

FIG. 7B is a side view illustrating an embodiment of the transceiver connector extension device of FIGS. 2A and 2B connected to a computing device in the immersion cooling system of FIG. 6.

FIG. 7C is a schematic view illustrating an embodiment of the transceiver connector extension device connected to the computing device in the immersion cooling system of FIG. 7B.

FIG. 8A is a side view illustrating an embodiment of the transceiver device of FIG. 5 being connected to the transceiver connector extension device and the computing device in the immersion cooling system of FIG. 7B.

FIG. 8B is a schematic view illustrating an embodiment of the transceiver device of FIG. 5 being connected to the transceiver connector extension device and the computing device in the immersion cooling system of FIG. 7C.

FIG. 8C is a schematic view illustrating an embodiment of the transceiver device of FIG. 5 connected to the transceiver connector extension device and the computing device in the immersion cooling system of FIG. 7C.

FIG. 8D is a side view illustrating an embodiment of the transceiver device of FIG. 5 connected to the transceiver connector extension device and the computing device in the immersion cooling system of FIG. 7B.

FIG. 9A is a side view illustrating an embodiment of a cabling system being connected to the transceiver device, the transceiver connector extension device, and the computing device in the immersion cooling system of FIG. 8D.

FIG. 9B is a side view illustrating an embodiment of a cabling system connected to the transceiver device, the transceiver connector extension device, and the computing device in the immersion cooling system of FIG. 8D.

FIG. 10 is a schematic view illustrating an embodiment of the computing device of FIG. 8C operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

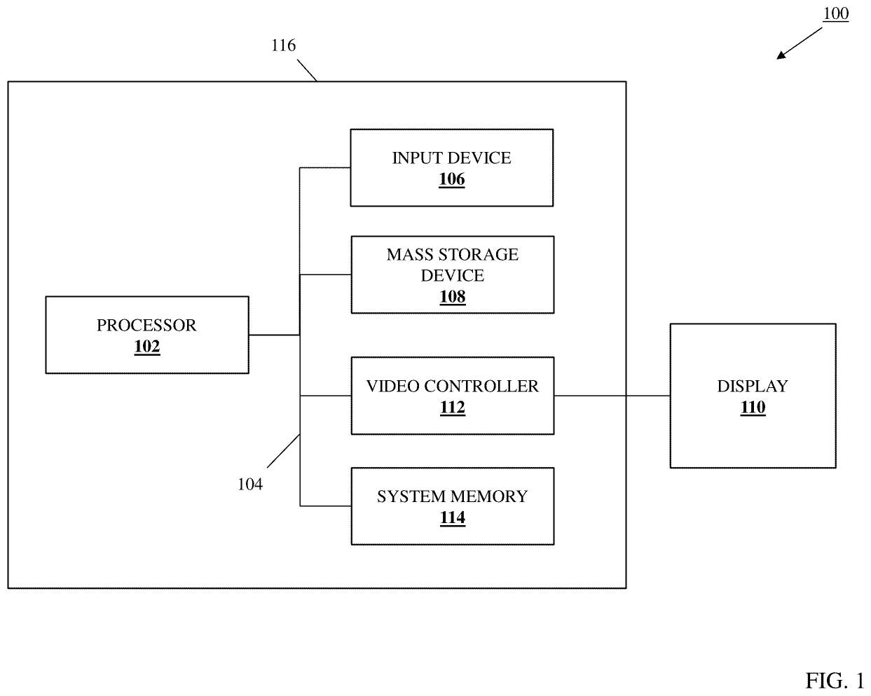

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

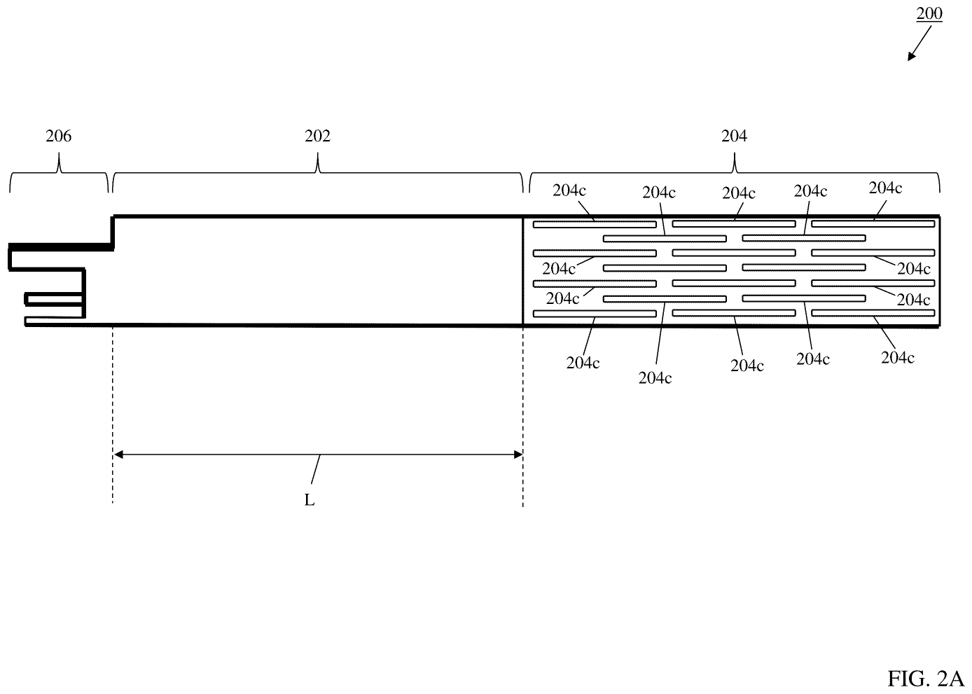

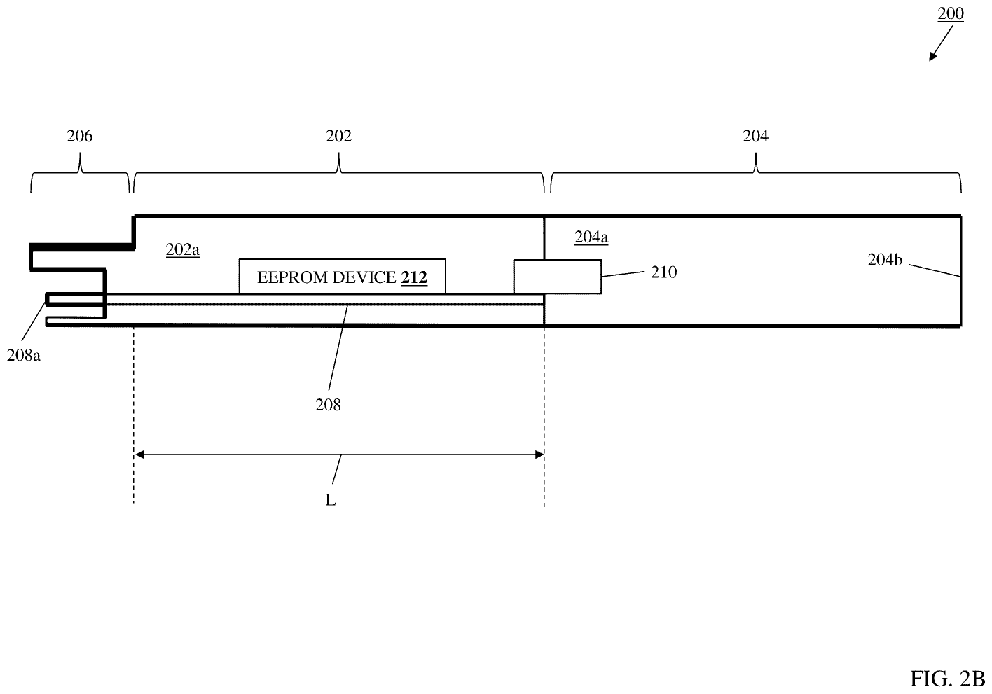

Referring now to FIGS. 2A and 2B, an embodiment of a transceiver connector extension device 200 is illustrated that may be provided in the transceiver connector extension system of the present disclosure. In the illustrated embodiment, the transceiver connector extension device 200 includes an extension device chassis 202 defining an extension device chassis housing 202a along its length that houses components of the transceiver connector extension device 200, only some of which are illustrated and described below. In the examples illustrated and described below, a transceiver cage 204 extends from the extension device chassis 202 and defines a transceiver housing 204a along its length having a transceiver entrance 204b opposite the transceiver cage 204 from the extension device chassis 202, and FIG. 2A illustrates how a plurality of immersion fluid slots 204c may be defined by the transceiver cage 204 such that they extend through the transceiver cage 204 to the transceiver housing 204a. While not illustrated or described in detail, one of skill in the art in possession of the present disclosure will appreciate how the transceiver cage 204 may include a variety of transceiver guide subsystems, transceiver securing subsystems, and/or other subsystems that one of skill in the art in possession of the present disclosure will recognize may be provided for transceiver devices used with the transceiver connector extension device 200 in order to enable the functionality discussed below.

As will be appreciated by one of skill in the art in possession of the present disclosure, the transceiver cage 204 in the examples illustrated and described below may be provided by a QSFP-DD cage (e.g., a Multi-Source Agreement (MSA) compliant QSFP cage) that is configured to accept QSFP-DD compatible transceiver devices (e.g., DAC transceiver devices, Active Optical Cable (AOC) transceiver devices, Active Electrical Cable (AEC) transceiver devices, Fibre Optic transceiver devices, etc.), but transceiver cages configured for use with any of a variety of different types of transceiver devices (e.g., Small Form-factor Pluggable (SFP)/SFP+ transceiver devices, QSFP+ transceiver devices, etc.) will fall within the scope of the present disclosure as well.

A computing device connector guide member 206 extends from the extension device chassis 202 opposite the extension device chassis 202 from the transceiver cage 204, and while the computing device connector guide member 206 is illustrated and described as being provided by a QSFP-DD guide member in the specific examples illustrated and described below, one of skill in the art in possession of the present disclosure will appreciate how the computing device connector guide member 206 may be provided by guide members for other types of connectors while remaining within the scope of the present disclosure as well.

As illustrated, the extension device chassis 202 may house a board 208 that supports the components of the transceiver connector extension device 200, only a few of which are illustrated and described below. While not illustrated in detail, one of skill in the art in possession of the present disclosure will appreciate how the board 208 may be provided by a Printed Circuit Board (PCB) and may be mounted to the extension device chassis 202 using “stand-off” elements or other mounting features known in the art. In the illustrated embodiment, a computing device connector 208a is included on an end of the board 208 such that it extends out of the extension device chassis housing 202a adjacent the computing device connector guide member 206. In the examples illustrated and described below, the computing device connector 208a is provided by a male QSFP-DD connector (e.g., an MSA compliant QSFP connector), but one of skill in the art in possession of the present disclosure will appreciate how the computing device connector 208a may be provided by other types of connectors while remaining within the scope of the present disclosure as well.

Furthermore, a transceiver connector 210 may be included on an end of the board 208 that is opposite the board 208 from the computing device connector 208a such that it extends out of the extension device chassis housing 202a and into the transceiver housing 204a. In the examples illustrated and described below, the transceiver connector 210 is provided by a female QSFP-DD connector, but one of skill in the art in possession of the present disclosure will appreciate how the transceiver connector 210 may be provided by other types of connectors while remaining within the scope of the present disclosure as well.

As illustrated in FIGS. 2A and 2B, the extension device chassis 202 includes a length L that separates the transceiver connector 210 from the computing device connector 208a and that, as described in further detail below, is configured to position a cable coupled to a transceiver device that is connected to the transceiver connector 210 out of an immersion fluid when the computing device connector 208a is connected to a port on a computing device that is provided in the immersion fluid. As such, one of skill in the art in possession of the present disclosure will appreciate how the length L provided for the extension device chassis 202 (i.e., the distance between the computing device connector 208a and the transceiver connector 210 that “extends” the connection of a transceiver device to a computing device as illustrated and described below) may be adjusted based on a depth of a corresponding port that is located in immersion fluid and to which the transceiver connector extension device 200 will be connected.

Furthermore, one of skill in the art in possession of the present disclosure will appreciate how, when the length L provided for the extension device chassis 202 (i.e., the distance between the computing device connector 208a and the transceiver connector 210 that “extends” the connection of a transceiver device to a computing device as illustrated and described below) is increased beyond some maximum amount (e.g., four inches), re-driver devices may be provided on the board 208 to compensate for signal losses that result from increased trace lengths through the board 208 from the port on the computing device to the transceiver connector 210.

In some embodiments, a storage device such as the Electronically Erasable Programmable Read-Only Memory (EEPROM) device 212 illustrated in FIG. 2B may be mounted to the board 208 and coupled to the computing device connector 208a via the board 208, and as described below may be configured to identify that the transceiver connector extension device 200 is provided between a computing device and a transceiver. Furthermore, the EEPROM device 212 may store (e.g., at address “0x55”) a manufacturer identifier, a part number, a serial number, and extension device chassis length information (e.g., information associated with the length L of the extension device chassis 202, a length of the transceiver cage 204, a combined length of the extension device chassis 202 and the transceiver cage 204, etc.) that, as described below, is available for use by a connected computing device in modifying pre-emphasis information.

While not illustrated or described in detail, one of skill in the art in possession of the present disclosure will appreciate how the board 208 may include traces or other couplings that provide ground (GND) couplings, power (Vcc) couplings, serial data (SDA) couplings, serial clock (SCL) couplings, and/or other couplings between the EEPROM device 212 and the computing device connector 208a; ground (GND) couplings, power (Vcc) couplings, low speed data transmission couplings, high speed (TX/RX) data transmission couplings, and/or other couplings (e.g., QSFP-DD couplings) between the transceiver connector 210 and the computing device connector 208a; and/or any other components or couplings that one of skill in the art in possession of the present disclosure would recognize as enabling the functionality described below. However, while a specific transceiver connector extension device 200 has been illustrated and described, one of skill in the art in possession of the present disclosure will recognize that transceiver connector extension devices (or other devices operating according to the teachings of the present disclosure in a manner similar to that described below for the transceiver connector extension device 200) may include a variety of components and/or component configurations for providing the transceiver connector extension functionality discussed below while remaining within the scope of the present disclosure as well.

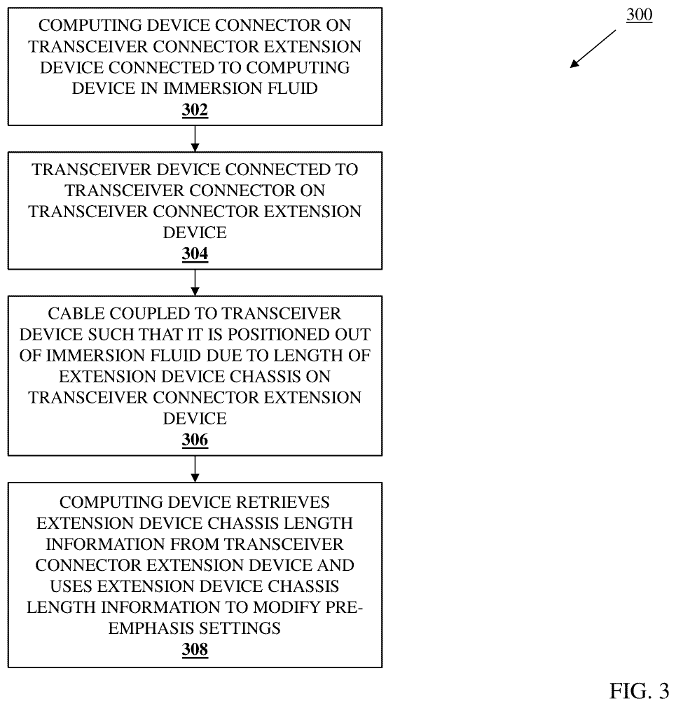

Referring now to FIG. 3, an embodiment of a method 300 for preventing immersion fluid cable damage using a transceiver connector extension device is illustrated. As discussed below, the systems and methods of the present disclosure provide a transceiver connector extension device that connects to a computing device immersed in immersion fluid, as well as to a transceiver device, and includes an extension device chassis having a length that is configured to position a cable connected to that transceiver device out of the immersion fluid. For example, the transceiver connector extension device of the present disclosure may include an extension device chassis. A computing device connector is located on a first end of the extension device chassis and is configured to connect to a computing device that is provided in an immersion fluid. A transceiver connector is located on a second end of the extension device chassis that is opposite the first end, and is configured to connect to a transceiver device. The extension device chassis is provided with a length that is configured, when the computing device connector is connected to the computing device that is provided in the immersion fluid and the transceiver device is connected to the transceiver connector, to position a cable coupled to the transceiver device out of the immersion fluid. As such, cables used to connect computing devices immersed in immersion fluid may be positioned out of the immersion fluid to prevent degradation of those cables that can cause damage that interferes with connectivity, which that can result in data loss, device downtime, and expenditure of relatively significant resources to identify damaged cables and replace them at regular intervals.

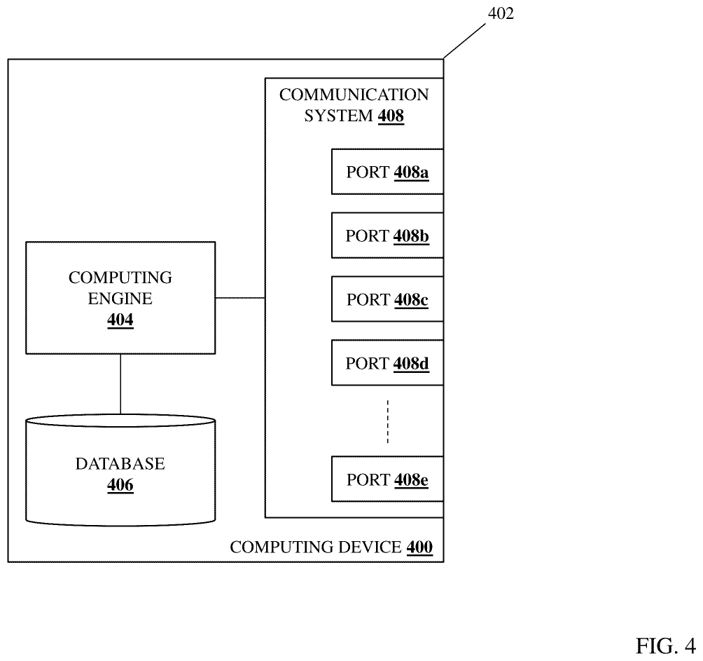

Referring now to FIG. 4, an embodiment of a computing device 400 is illustrated that is used with the transceiver connector extension device 200 during the embodiments of the method 300 described below. In an embodiment, the computing device 400 may be provided by the IHS 100 discussed above with reference to FIG. 1 and/or may include some or all of the components of the IHS 100, and in the specific examples below is described as being provided by a networking device such as a switch device. However, while illustrated and discussed as being provided by a switch device, one of skill in the art in possession of the present disclosure will recognize that the functionality of the computing device 400 discussed below may be provided by other devices that are configured to operate similarly as the computing device 400 discussed below.

In the illustrated embodiment, the computing device 400 includes a chassis 402 that houses the components of the computing device 400, only some of which are illustrated and described below. For example, the chassis 402 may house a processing system (not illustrated, but which may be similar to the processor 102 discussed above with reference to FIG. 1) and a memory system (not illustrated, but which may be similar to the memory 114 discussed above with reference to FIG. 1) that is coupled to the processing system and that includes instructions that, when executed by the processing system, cause the processing system to provide a computing engine 404 that is configured to perform the functionality of the computing engines and/or computing devices discussed below.

The chassis 402 may also house a storage system (not illustrated, but which may include the storage 108 discussed above with reference to FIG. 1) that is coupled to the computing engine 404 (e.g., via a coupling between the storage system and the processing system) and that includes a database 406 that is configured to store any of the information utilized by the computing engine 404 discussed below. The chassis 402 may also house a communication system 408 that is coupled to the computing engine 304 (e.g., via a coupling between the communication system 308 and the processing system) and that includes a plurality of ports 408a, 408b, 408c, 408d and up to 408e. However. while a specific computing device 400 has been illustrated and described, one of skill in the art in possession of the present disclosure will recognize that computing devices (or other devices operating according to the teachings of the present disclosure in a manner similar to that described below for the computing device 400) may include a variety of components and/or component configurations for providing conventional computing device functionality, as well as the transceiver connector extension functionality discussed below, while remaining within the scope of the present disclosure as well.

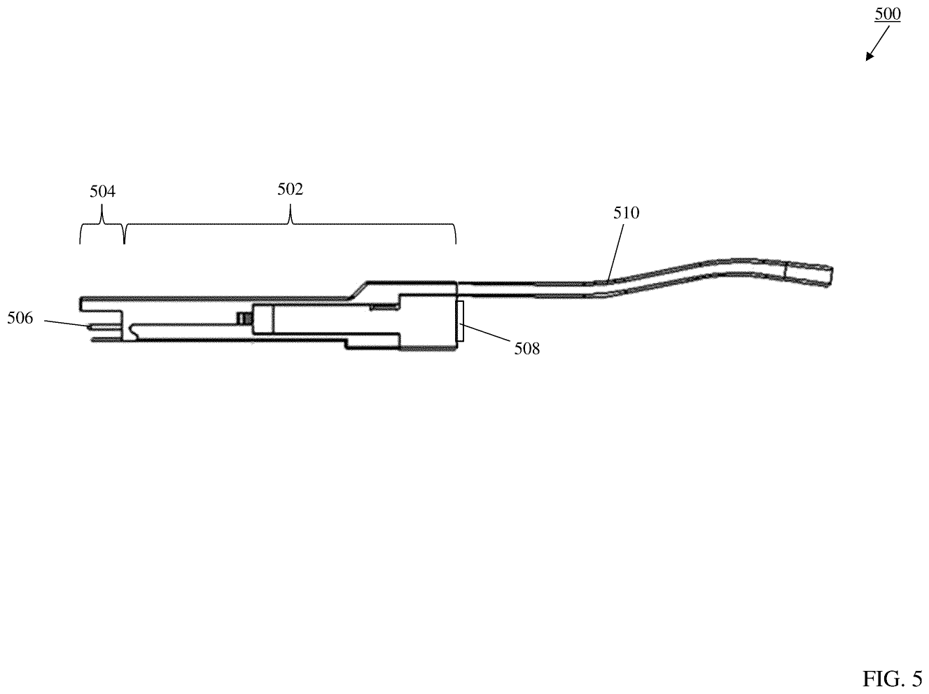

With reference to FIG. 5, an embodiment of a transceiver device 500 is illustrated that is used with the transceiver connector extension device 200 during the embodiments of the method 300 described below, and while the transceiver device 500 is illustrated and described as being provided by a conventional QSFP-DD transceiver device, one of skill in the art in possession of the present disclosure will appreciate how other types of transceiver devices will fall within the scope of the present disclosure. In the illustrated embodiment, the transceiver device 500 includes a transceiver chassis 502 that houses the components of the transceiver device 500. A computing device connector guide member 504 (e.g., a QSFP guide member in the illustrated example) extends from the transceiver chassis 502, and a computing device connector 506 (e.g., a male QSFP-DD connector in the illustrated example) extends from the transceiver chassis 502 adjacent the computing device connector guide member 504. A cable connector 508 is located on the transceiver chassis 502 opposite the transceiver chassis 502 from the computing device connector 506 and the computing device connector guide member 504, and a release member 510 extends from the transceiver chassis 502 adjacent the cable connector 508.

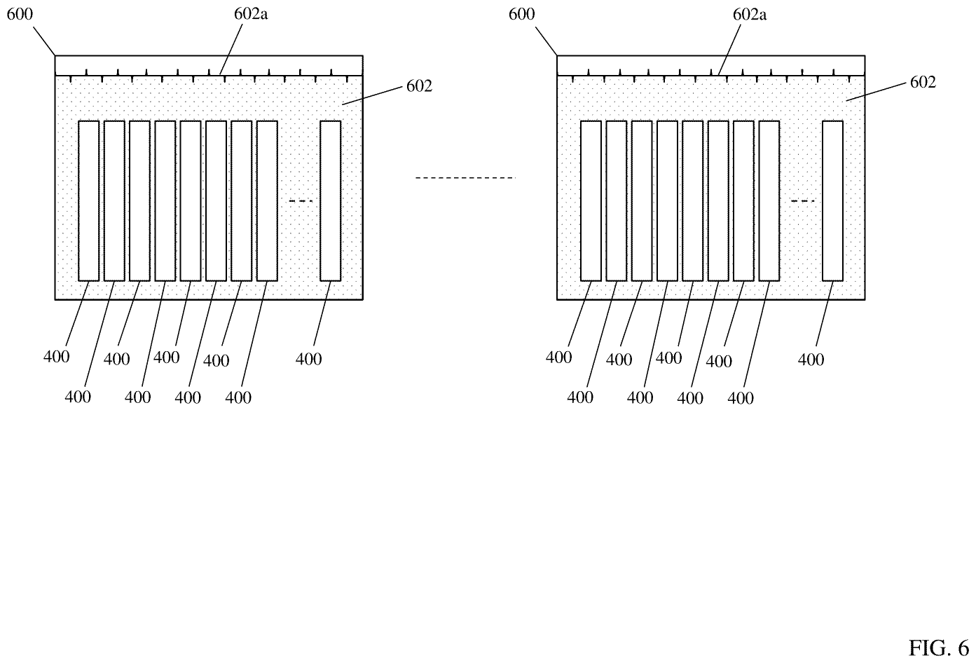

With reference to FIG. 6, a plurality of immersion cooling racks 600 and up to 602 may be provided, with a plurality of the computing devices 400 discussed above with reference to FIG. 4 included in the immersion cooling racks 600, and with an immersion fluid 602 provided in each of the immersion cooling racks 600. For example, one of skill in the art in possession of the present disclosure will appreciate how the computing devices 400 may be provided in their respective immersion cooling racks 600, and then those immersion cooling racks 600 may be filled with the immersion fluid 602 that, as discussed above, may be provided by dielectric, electrically non-conductive immersion fluid that has a significantly higher thermal conductivity than air such that a surface 602a of the immersion fluid 602 is located above the computing devices 400. To provide a specific example, the computing devices 400 may include one or more networking devices (e.g., switch devices) and server devices, although other types and/or combinations of computing devices will fall within the scope of the present disclosure as well.

Furthermore, while not illustrated or described in detail, one of skill in the art in possession of the present disclosure will appreciate how the immersion cooling racks 600 may include immersion fluid circulation systems that are configured to circulate the immersion fluid 602, heat exchanger devices that are configured to remove heat from immersion fluid 602 as it is circulated, and/or any other immersion cooling components known in the art. Further still, while the immersion cooling racks 600 are described as being filled with the immersion fluid 602 prior to connecting the transceiver connector extension devices, transceiver devices, and cables to the computing devices 400, one of skill in the art in possession of the present disclosure will appreciate how the transceiver connector extension devices, transceiver devices, and cables may be connected to the computing devices 400 (i.e., the computing devices in the immersion cooling racks may be “cabled” and/or otherwise inter-connected) prior to the immersion cooling racks 600 being filled with the immersion fluid 602 while remaining within the scope of the present disclosure as well.

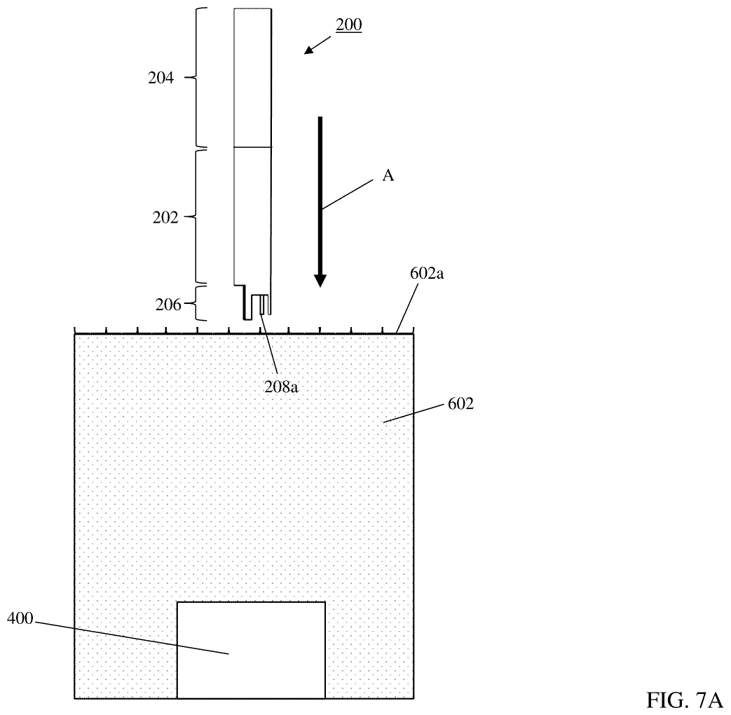

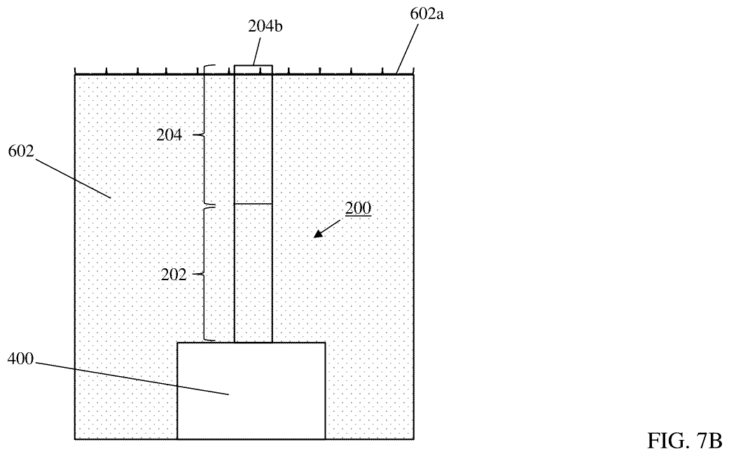

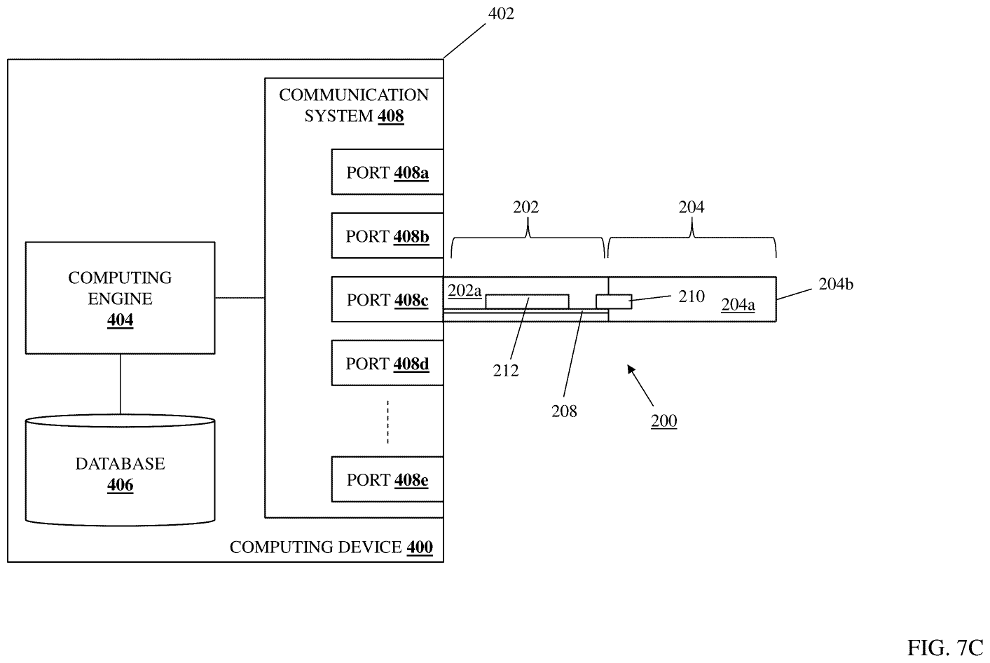

The method 300 begins at block 302 where a computing device connector on a transceiver connector extension device is connected to a computing device in immersion fluid. As will be appreciated by one of skill in the art in possession of the present disclosure, while a single transceiver connector extension device is illustrated and described as being connected to a single computing device below, a respective transceiver connector extension device may be connected to each computing device 400 in the immersion cooling systems 600 that will be connected to a cable similarly as described below while remaining within the scope of the present disclosure as well. With reference to FIGS. 7A, 7B, and 7C, in an embodiment of block 302, the transceiver connector extension device 200 may be positioned adjacent one of the computing devices 400 in the immersion fluid 602 such that the computing device connector 208a on the transceiver connector extension device 200 is facing and aligned with the port 408c on the computing device 400. The transceiver connector extension device 200 is then moved in a direction A such that the transceiver connector extension device 200 enters the immersion fluid 602 and the computing device connector guide member 206 engages features on the chassis 402 of the computing device 400 to guide the computing device connector 208a into engagement with the port 408c.

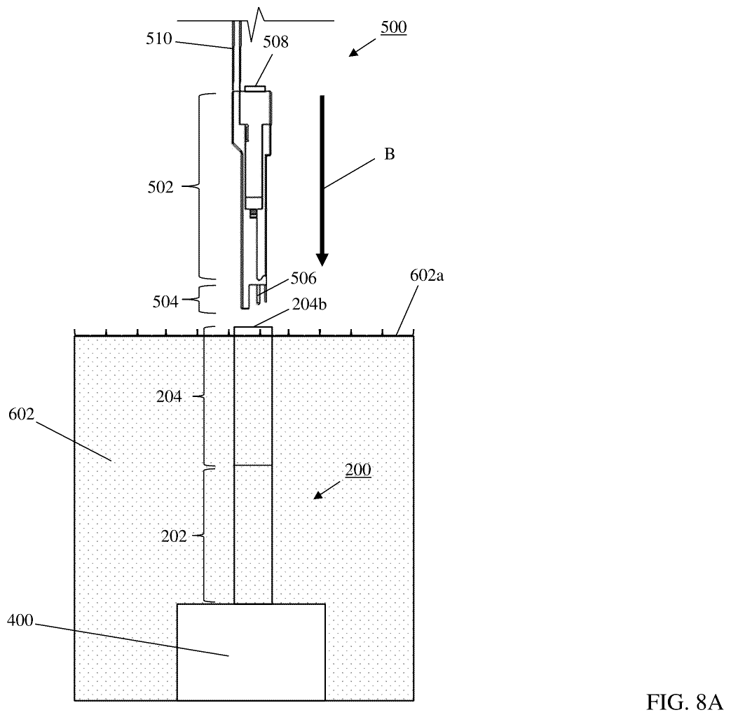

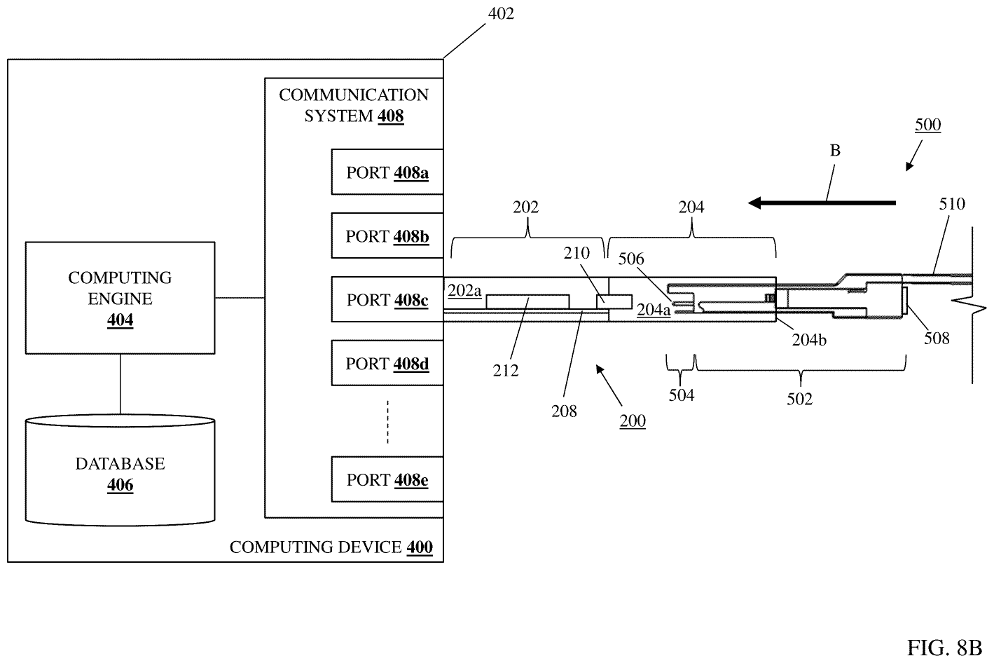

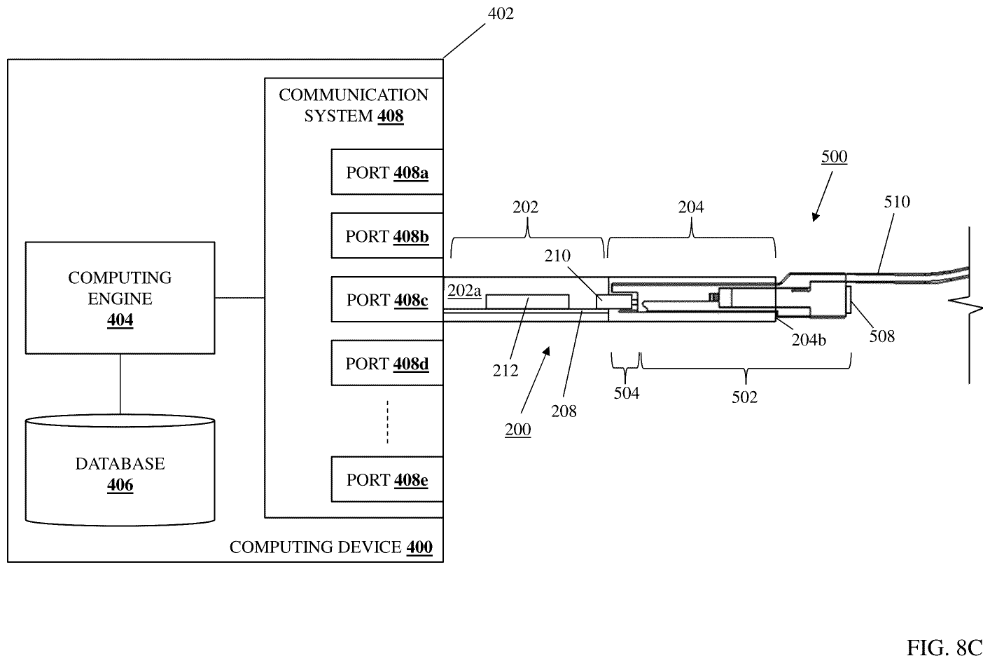

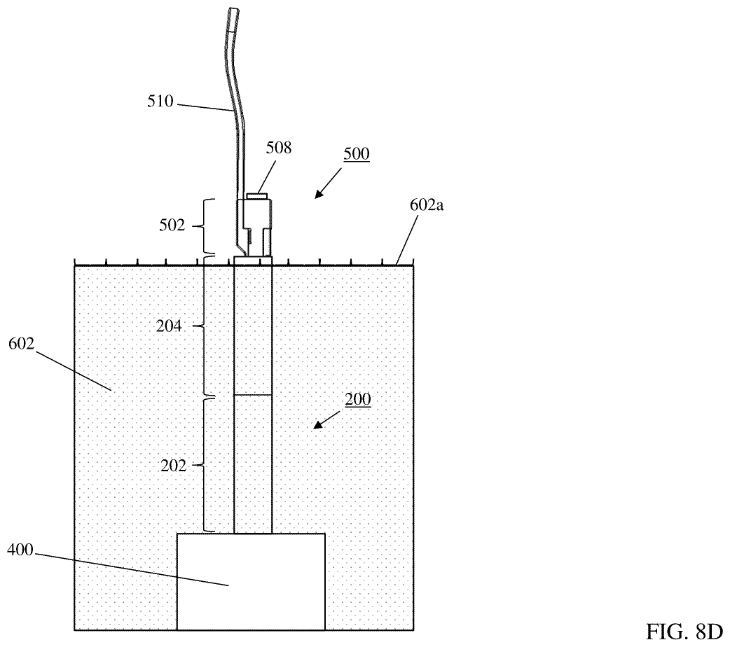

The method 300 then proceeds to block 304 where a transceiver device is connected to a transceiver connector on the transceiver connector extension device. With reference to FIGS. 8A, 8B, 8C, and 8D, in an embodiment of block 304, the transceiver device 500 may be positioned adjacent the transceiver connector extension device 200 that was positioned in the immersion fluid 602 at block 302 such that the computing device connector 506 on the transceiver device 500 is facing and aligned with the transceiver entrance 204b defined by the transceiver cage 204. The transceiver device 500 is then moved in a direction B such that the transceiver device 500 enters the transceiver housing 204a defined by the transceiver device 204 via the transceiver entrance 204b, and the computing device connector guide member 504/transceiver chassis 502 engage features on the transceiver cage 204 to guide the computing device connector 506 into engagement with the transceiver connector 210 on the transceiver connector extension device 200.

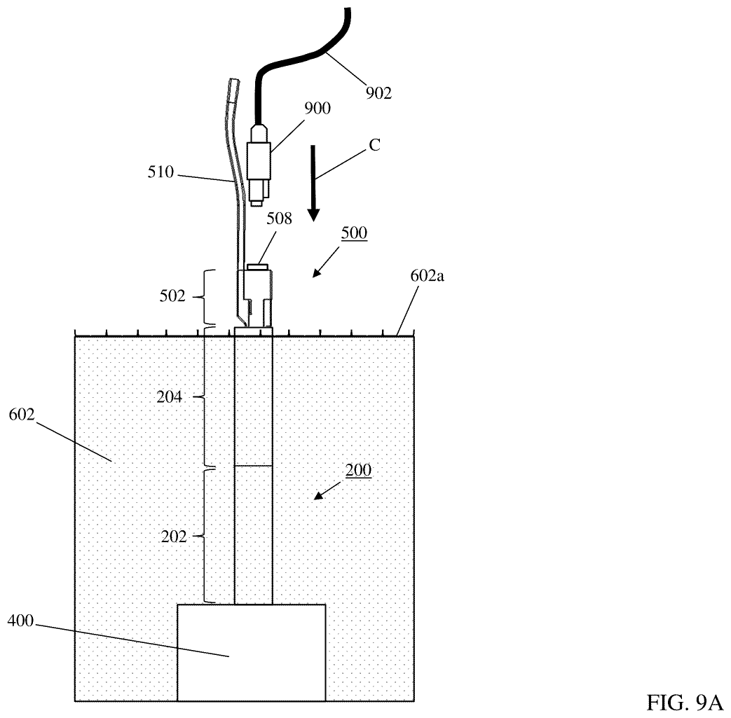

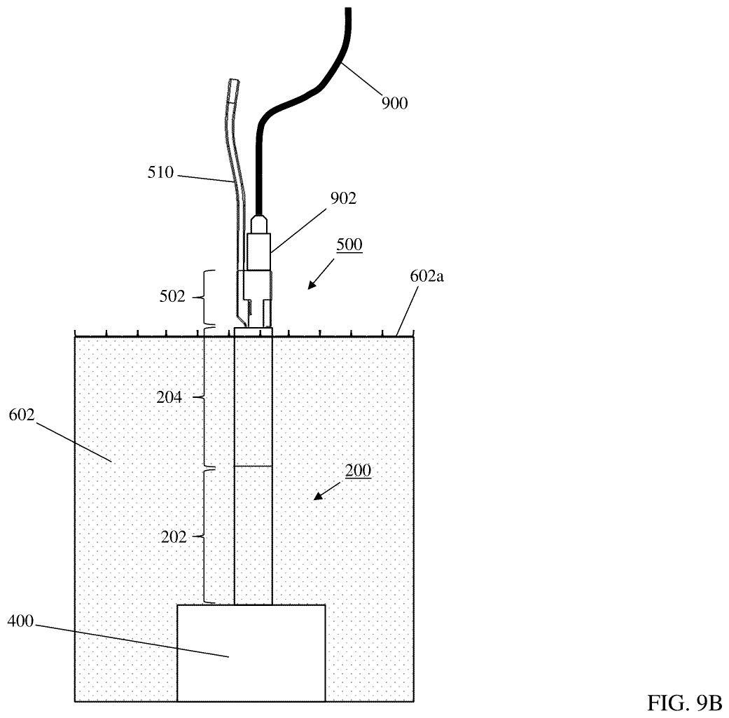

The method 300 then proceeds to block 306 where a cable is coupled to the transceiver device such that it is positioned out of the immersion fluid due to a length of the extension device chassis on the transceiver connector extension device. With reference to FIGS. 9A and 9B, in an embodiment of block 306, a cable connector 900 included on an end of a cable 902 may be positioned adjacent the cable connector 508 on the transceiver device 500 connected to the transceiver connector extension device 200 that was positioned in the immersion fluid 602 at block 302 such that the cable connector 900 included on the end of the cable 902 is facing and aligned with the cable connector 508 on the transceiver device 500. The cable connector 900 included on the end of the cable 902 is then moved in a direction C such that the cable connector 900 included on the end of the cable 902 engages the cable connector 508 on the transceiver device 500.

As can be seen in FIG. 9B, with the cable connector 902 connected to the transceiver device 500 that is connected to the transceiver connector extension device 200 that is located in the immersion fluid 602 and connected to the computing device 400, the cable 900 is positioned out of the immersion fluid 602. As such, one of skill in the art in possession of the present disclosure will appreciate how cables used with the transceiver connector extension system of the present disclosure are not immersed in immersion fluid, and thus will not become hardened, brittle, and/or otherwise degrade over time, and will not be subject to reductions in their flexibility and corresponding damage that can occur with immersion fluid immersed cables. While the specific examples illustrated and describe above positioned the end of the transceiver cage 204, a portion of the transceiver device 500, and the cable connector 902 out of the immersion fluid 602, one of skill in the art in possession of the present disclosure will appreciate how any or all of that portion of the transceiver cage 204, that portion of the transceiver device 500, and the cable connector 902 may be partially or totally immersed in the immersion fluid 602 while the cable 900 is located out of the immersion fluid 602 while remaining within the scope of the present disclosure as well.

One of skill in the art in possession of the present disclosure will appreciate how the transceiver connector extension device 200 may enhance the cooling of the transceiver device 500 relative to conventional transceiver device coupling systems, as the transceiver cage 204 (and a majority of the transceiver device 500 in embodiments that include the plurality of immersion fluid slots 204c that are defined by the transceiver cage 204 and that may allow the immersion fluid 602 to enter the transceiver housing 204b and surround the portion of the transceiver chassis 502 that has been immersed in the immersion fluid 602) is surrounded on all sides by the immersion fluid 602 as compared to conventional transceiver device coupling systems that mount the transceiver cage to a circuit board and prevent immersion fluid from engaging the transceiver cage on at least one of its sides that is mounted to the circuit board.

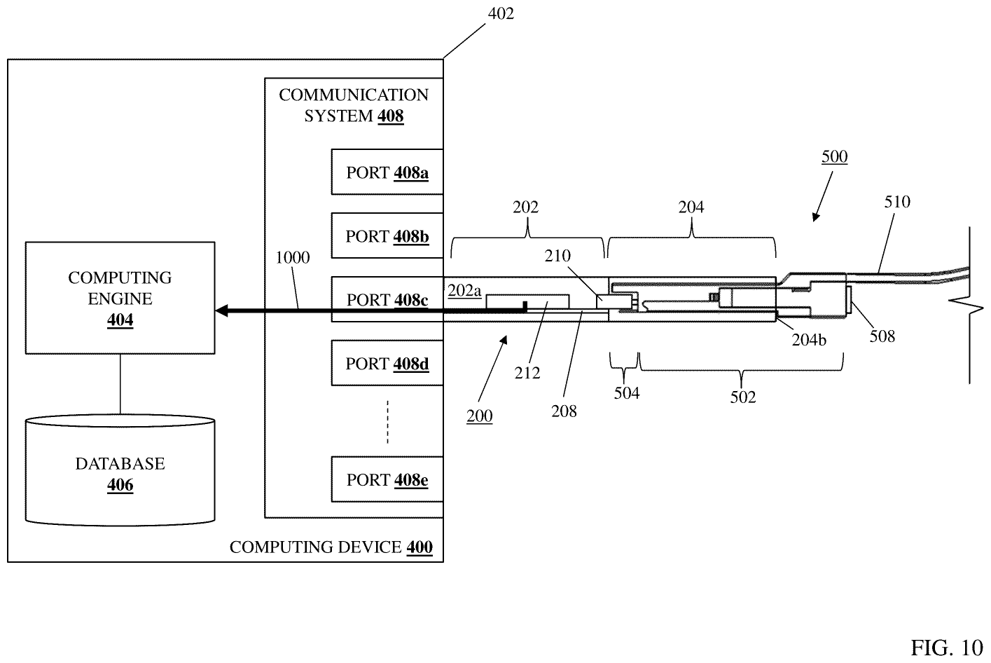

The method 300 then proceeds to block 308 where the computing device retrieves extension device chassis length information from the transceiver connector extension device and uses the extension device chassis length information to modify pre-emphasis settings. With reference to FIG. 10, in an embodiment of block 308, the computing engine 404 in the computing device 400 may perform extension device chassis length information retrieval operations 1000 that may include retrieving the extension device chassis length information from the EEPROM device 212 via the board 208, the computing device connector 208a, and the port 408c. As will be appreciated by one of skill in the art in possession of the present disclosure, during manufacture of the computing device 400, the computing engine 404 may be provided with original pre-emphasis settings (e.g., stored in the database 406) that may provide signal integrity parameters for use by a serializer/deserializer (serdes) subsystem in the computing device 400 in shaping signals output from the ports 40a-408e into relatively “clean” and well-defined signals (e.g., by cancelling out reflection, signal attenuation, and/or other factors) based on characteristics of the signal traces or other transmission lines/couplings between the computing engine 404 and the ports 408a-408c.

As such, the extension device chassis length information retrieved at block 308 by the computing engine 404 may include any information that takes into account the characteristics of the signal traces or other transmission lines/couplings between the computing device connector 208a and the transceiver connector 210, and one of skill in the art in possession of the present disclosure will appreciate how that extension device chassis length information may be used by the computing engine 404 to modify the original pre-emphasis settings to provide modified pre-emphasis settings that take into account the addition of the signal traces or other transmission lines/couplings between the ports 408a-408c and the transceiver connector 210 on the transceiver connector extension device 200. As such, following block 308, the modified pre-emphasis settings may be stored in the database 406 and subsequently used by the computing engine 404 to provide signal integrity parameters for use by a serdes subsystem in the computing device 400 in shaping signals output from its ports 40a-408e and via the transceiver connector extension device 200 to the transceiver device 500 into relatively “clean” and well-defined signals (e.g., by cancelling out reflection, signal attenuation, and/or other factors) based on characteristics of the signal traces or other transmission lines/couplings between the computing engine 404 and the transceiver connector 210 on the transceiver connector extension device 200.

However, while a specific example has been provided above, one of skill in the art in possession of the present disclosure will appreciate how a wide variety of modification to the transceiver connector extension system of the present disclosure will fall within the scope of the present disclosure. For example, port Light Emitting Devices (LEDs) may be provided on the transceiver connector extension device 200 (e.g., on the extension device chassis 202, the transceiver cage 204, etc.), and may be driven by the computing engine 404 in order to allow for the identification of the status of a connected port (e.g., the port 408c immersed in the immersion fluid 602 as described in the examples above).

Furthermore, while the transceiver connector extension system of the present disclosure is described in detail above as being used in immersion cooling systems, one of skill in the art in possession of the present disclosure will appreciate how the transceiver connector extension device of the present disclosure will provide benefits when used in air cooled systems as well (e.g., the enhanced cooling benefits provided by the transceiver connector extension device relative to conventional transceiver coupling systems discussed above). Further still, two of the inventors of the present disclosure have developed a penta-port-cage system that includes embodiments that utilize the transceiver connector extension system of the present disclosure, and a description of those embodiments is provided in U.S. patent application Ser. No. ______, attorney docket no. 137817.01, filed on ______, the disclosure of which is incorporated by reference herein in its entirety.

Thus, systems and methods have been described that provide a transceiver connector extension device that connects to a computing device immersed in immersion fluid, as well as to a transceiver device, and includes an extension device chassis having a length that is configured to position a cable connected to that transceiver device out of the immersion fluid. For example, the transceiver connector extension device of the present disclosure may include an extension device chassis. A computing device connector is located on a first end of the extension device chassis and is configured to connect to a computing device that is provided in an immersion fluid. A transceiver connector is located on a second end of the extension device chassis that is opposite the first end, and is configured to connect to a transceiver device. The extension device chassis is provided with a length that is configured, when the computing device connector is connected to the computing device that is provided in the immersion fluid and the transceiver device is connected to the transceiver connector, to position a cable coupled to the transceiver device out of the immersion fluid. As such, cables used to connect computing devices immersed in immersion fluid may be positioned out of the immersion fluid to prevent degradation of those cables that can cause damage that interferes with connectivity, and that can result in data loss, device downtime, and expenditure of relatively significant resources to identify damaged cables and replace them at regular intervals.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A transceiver connector extension device, comprising:
an extension device chassis;
a computing device connector that is located on a first end of the extension device chassis and that is configured to connect to a computing device that is provided in an immersion fluid; and
a transceiver connector that is located on a second end of the extension device chassis that is opposite the first end, and that is configured to connect to a transceiver device, wherein the extension device chassis is provided with a length that is configured, when the computing device connector is connected to the computing device that is provided in the immersion fluid and the transceiver device is connected to the transceiver connector, to position a cable coupled to the transceiver device out of the immersion fluid.

2. The system of claim 1, further comprising:
a transceiver cage that extends from the extension device chassis and that defines a transceiver housing that is configured to house the transceiver device when the transceiver device is connected to the transceiver connector.

3. The system of claim 2, further comprising:
a plurality of immersion fluid slots that are defined by the transceiver cage and that are configured to allow immersion fluid to enter the transceiver housing when the computing device connector is connected to the computing device that is provided in the immersion fluid.

4. The system of claim 2, wherein the transceiver cage includes a first portion that is configured to be located in the immersion fluid when the computing device connector is connected to the computing device that is provided in the immersion fluid, and a second portion that is configured to be located out of the immersion fluid when the computing device connector is connected to the computing device that is provided in the immersion fluid.

5. The system of claim 1, further comprising:
a storage device that is housed in the extension device chassis, that is coupled to the computing device connector, and that stores extension device chassis length information that is configured for use in modifying pre-emphasis settings in the computing device.

6. The system of claim 1, wherein computing device connector is a male Quad Small Form-factor Pluggable (QSFP) connector, and the transceiver connector is a female QSFP connector.

7. An Information Handling System (IHS), comprising:
an Information Handling System (IHS) chassis that is immersed in an immersion fluid;
a port that is accessible on the IHS chassis;
a processing system that is housed in the IHS chassis and coupled to the port;
a transceiver connector extension device that includes:
an extension device chassis including an IHS connector that is located on a first end of the extension device chassis and that is connected to the port; and
a transceiver connector that is located on a second end of the extension device chassis that is opposite the first end;
a transceiver device that is connected to the transceiver connector; and
a cable that is coupled to the transceiver device, wherein the extension device chassis is provided with a length that positions the cable out of the immersion fluid.

8. The IHS of claim 7, further comprising:
a transceiver cage that extends from the extension device chassis and that defines a transceiver housing that houses the transceiver device.

9. The IHS of claim 8, further comprising:
a plurality of immersion fluid slots that are defined by the transceiver cage and that allow immersion fluid to enter the transceiver housing.

10. The IHS of claim 8, wherein the transceiver cage includes a first portion that is located in the immersion fluid, and a second portion that is located out of the immersion fluid.

11. The IHS of claim 7, further comprising:
a storage device that is housed in the extension device chassis, that is coupled to the IHS connector, and that stores extension device chassis length information.

12. The IHS of claim 7, wherein the processing system is configured to:
retrieve, via the port and the IHS connector, the extension device chassis length information; and
modify, using the extension device chassis length information, pre-emphasis settings.

13. The IHS of claim 7, wherein the IHS connector is a male Quad Small Form-factor Pluggable (QSFP) connector, and the transceiver connector is a female QSFP connector.

14. A method for preventing immersion fluid cable damage using a transceiver connector extension device, comprising:
connecting, by a computing device connector on an extension device chassis of a transceiver connector extension device, to a computing device that is provided in an immersion fluid;
connecting, by a transceiver connector that is located on a second end of the extension device chassis that is opposite the first end, to a transceiver device;
coupling, by the transceiver connector extension device to the computing device, a cable that is coupled to the transceiver device, wherein the extension device chassis is provided with a length that positions the cable coupled to the transceiver device out of the immersion fluid.

15. The method of claim 14, further comprising:
housing, by a transceiver cage that extends from the extension device chassis, the transceiver device in a transceiver housing defined by the transceiver cage.

16. The method of claim 15, further comprising:
allowing, by a plurality of immersion fluid slots that are defined by the transceiver cage, immersion fluid to enter the transceiver housing.

17. The method of claim 14, wherein the transceiver cage includes a first portion that is located in the immersion fluid, and a second portion that is located out of the immersion fluid.

18. The method of claim 14, further comprising:
storing, by a storage device that is housed in the extension device chassis and that is coupled to the computing device connector, extension device chassis length information.

19. The method of claim 14, further comprising:
retrieving, by the computing device via the computing device connector, the extension device chassis length information; and
modifying, by the computing device using the extension device chassis length information, pre-emphasis settings.

20. The method of claim 14, wherein computing device connector is a male Quad Small Form-factor Pluggable (QSFP) connector, and the transceiver connector is a female QSFP connector.
